(19) United States
(12) Patent Application Publication
(10) Pub. No.: US 2002/0138596 A1
(43) Pub. Date: Sep. 26, 2002

(54) Method to proxy IP services

(76) Inventors: Matthew Darwin, Ottawa (CA); David Schenkel, Ottawa (CA); Dariush Eslimi, Ottawa (CA); Michael Slavitch, Ottawa (CA)

Correspondence Address: Shapiro Cohen, P.O. Box 3440, Station D, Ottawa, K1P 6P1, CA

(21) Appl. No.: 10/092,579

(22) Filed: Mar. 8, 2002

Related U.S. Application Data
(60) Provisional application No. 60/274,209, filed on Mar. 9, 2001.

(51) Int. Cl. G06F 15/177

(52) U.S. Cl. 709/220

(57) ABSTRACT

A method for providing a proxy service in a computer network, comprising the steps of: receiving a request to access a device, determining the path to the device, ascertaining what firewall rules exist for that given path, and redirecting the client to the appropriate proxy, if any is needed, for that path.

This application relates to U.S. provisional application No. 60/274,209 filed Mar. 9, 2001.

### FIELD OF THE INVENTION

The present invention relates to a method to proxy IP services on devices that are located within networks that have non-routable private addresses.

### BACKGROUND TO THE INVENTION

With the proliferation of TCP/IP technology worldwide, including outside the Internet itself, an increasing number of enterprises have used private Internet addresses for intra-enterprise communications, without any intention to ever directly connect to other enterprises or the Internet itself. Such addresses are not globally unique, and often not even organizationally unique. Such networks use Network Address Translation (NAT) to communicate with devices outside their domain.

Network Address Translation (NAT) is a known method by which IP addresses are mapped from one realm to another, in an attempt to provide transparent routing to hosts. Traditionally, NAT devices are used to connect an isolated address realm with private unregistered addresses to an external realm with globally unique registered addresses. In a typical NAT configuration a single externally visible IP host acts as a transparent gateway to the private Internet addresses with a network. The devices in the private network appear to have the same IP address to devices outside the domain. There is no way to discriminate between them. This is called one-to-many NAT. Such a scheme has allowed rapid deployment of enterprise TCP/IP networks as it permits enterprises to have extreme flexibility with the number of IP addresses that they can use internally while still having transparent access to Internet services.

A problem exists when dealing with multiple domains of private addresses, as they are not globally unique. A single enterprise may have several departments that each uses the same private addressing scheme. An external vendor may have several clients that have numbering that is organizationally unique, but has conflict with the addressing in other organizations. This is a common problem, as there are only three sets of private Internet addresses. The Internet Assigned Numbers Authority (IANA) has reserved the following three blocks of the IP address space for private Internets:

10.0.0.0-10.255.255.255 (10/8 prefix)

172.16.0.0-172.31.255.255 (172.16/12 prefix)

192.168.0.0-192.168.225.225 (192.168/16 prefix)

Note that the first block is nothing but a single class A network number, while the second block is a set of 16 contiguous class B network numbers, and the third block is a set of 256 contiguous class C network numbers. An enterprise that decides to use IP addresses out of the address space defined in this document can do so without any coordination with IANA or an Internet registry. The address space can thus be used by many enterprises. This has created a situation where there is massive addressing conflict between networks.

TCP/IP routing requires that all hosts in the routed domain be unique. There cannot be any conflicts. In networks where there are private address ranges the networks must be isolated via methods such as one-to-many NAT. Such devices will be able to create sessions with devices on other networks that have globally unique addresses. However, an outside device will see it as a connection from the masquerading host, not the actual device. Furthermore, devices outside these networks cannot create sessions with devices inside these networks using the actual IP address of the devices in question, as the one-to-many relationship only works one way and traditional IP routing has no solution for accessing private networks from the public network and cannot operate at all if these are IP address conflicts.

There is no need for methods that allow access to devices in private networks from the public network. There is also a need for methods that uniquely identify devices that have private IP addresses even when these addresses are in conflict with those in other networks. The methods have to take into account a variety of network topologies and path routes between a client and a device with which it wises to communicate.

Identification of Devices

A network management system discovers devices and their attributes. Apart from an IP address, devices may have Media Access Control (MAC) addresses, unique and local DNS names, SNMP system names, Windows names and several other discriminators. The user can select a device uniquely using one of a choice of metrics. The number of possible discriminators is unbounded and changing. New metrics, such as Voice over IP telephone number, are appearing as new products appear.

A network management system determines the physical topology of one or more networks. Determining the physical topology of the network allows a master proxy to determine that more than one device in its list has the same IP address and be able to discriminate between them. This is possible if an only if the topology is not referenced by IP address but by a different discriminator. In systems that use IP address as database key such discrimination is impossible. The method in U.S. Pat. No. 5,926,462 issued Jul. 20, 1999 to Schenkel et al could be used to create a topology database that allows such discrimination.

Firewall Rules

A network may have a set of firewall rules that cannot be obtained by a network management system. An additional data source describing this information will be needed. A device inventory with attributes and connectivity information in conjunction with the rules needed to access firewalls in the network completes the seeding of proxies.

### SUMMARY OF THE INVENTION

The present invention uses a network management system to identify and place devices. HTTP redirection and proxy servers are used to select and access devices that have IP address range conflicts with other devices, and in non-routable private networks, or behind network firewalls. A master proxy then determines which proxies, if any, are used to communicate with a specific device. A user accesses the service via an HTTP compliant client. The primary proxy then redirects the client to the appropriate device, be it the device itself or a proxy for the device. The URL of the request contains within itself a message that allows the proxy to find out which device is being acted upon and what protocol action to take. Like HTTP itself the protocol is connectionless. Each request requires a unique HTTP session. The method is compliant with HTTP protocols 0.9, 1.0 and 1.1.

In accordance with an embodiment of the invention, a method for providing a proxy service in a computer network, is comprised of the steps of: receiving a request to access a device, determining the path to the device, ascertaining what firewall rules exist for that given path, and redirecting the client to the appropriate proxy, if any is needed, for that path.

Selection of Paths

The method of the present invention allows for four proxy methods for a given device.

1. A proxy server identifies the device and the client can access the device directly.

2. A proxy server can identify and access the device but it is inaccessible to the client.

3. A proxy server can identify the device but access is through a second proxy server. The second proxy server is accessible to the client.

4. A proxy server can identify the device but access is through a second proxy server. The second proxy server is inaccessible to the client.

The methods are recursive. Methods 3 and 4 are recursions of 1 and 2, and the methods can be joined and extended indefinitely. Once a proxy is seeded it can determine which path to take to make a proxy connection between a client and a device.

HTTP Redirection

The invention redirects clients to the device or proxy by using an HTTP redirect message which informs the client of the address to which to redirect itself.

Transparent Proxies

Each proxy acts transparently and cumulatively. No client-side configuration for the proxy is needed.

Authentication

The master proxy server has an authentication and access control method for the client. Authentication between proxies is transparent to the user. Such authentication can be either in-band, via cookies or basic HTTP authentication, or out of band, by access control lists or database lookups. Connectionless Protocol

HTTP is a connectionless protocol, each request is an independent session. In HTTP protocol versions 0.9 and 1.0, once a document is transmitted the TCP session closes. However, HTTP 1.1 allows for a TCP socket to remain open after the request has been made. The invention allows for maximum flexibility in determining which, if any TCP sessions remain open.

### BRIEF DESCRIPTION OF THE DRAWINGS

A person understanding the above-described invention may now conceive of alternative designs, using the principles described herein. All such designs which fall within the scope of the claims appended hereto are considered to be part of the present invention.

FIG. 1 is a block diagram of a circuit for configuring proxies;

FIG. 2 is a block diagram of a proxy server redirecting to an HTTP server;

FIG. 3 is a block diagram of a proxy server forwarding to an HTTP server;

FIG. 4 is a block diagram of a proxy server redirecting via a second proxy server to an HTTP server; and

FIG. 5 is a block diagram of a proxy session through multiple proxy servers to an HTTP server.

### DETAILED DESCRIPTION OF THE INVENTION

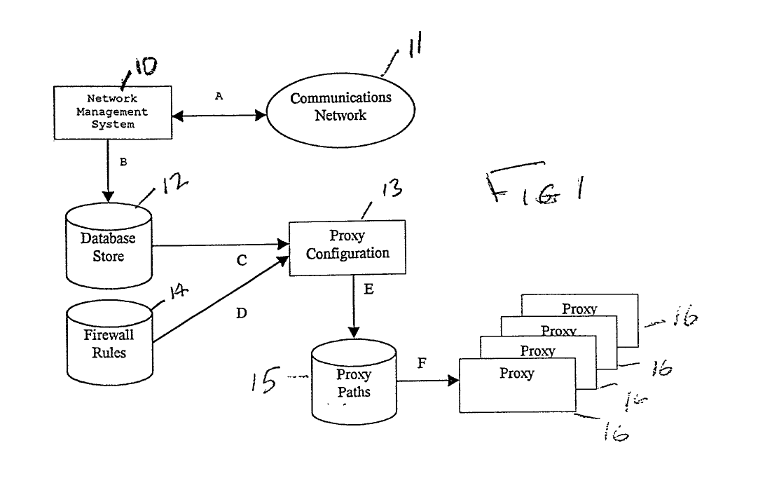

Referring to FIG. 1, there is shown a block diagram of a system for configuring proxy servers, hereinafter proxies. The lower portion of the drawing graphically shows the state transitions of the system of FIG. 1. A network management system (NMS) 10 is connected to a communications network 11 and to a database store 12. Initially the NMS10 discovers devices and their attributes, which is illustrated graphically at A between 10 and 11 and as step A in the state transitions. Next the NMS 10 stores devices attributes and their connectivity in the database 12, as shown at B in the drawings. The proxy configuration 13 is seeded device and attribute information as well as device location at C. Firewall information from Firewall Rules 14 is fed to the proxy configuration 13 at step D. The supplying of firewall information may either be manual or automatic. Proxy paths 15 between device pairs are determined and stored at step E. Proxies 16 then obtain the path list from proxy paths 15 at step F and are configured.

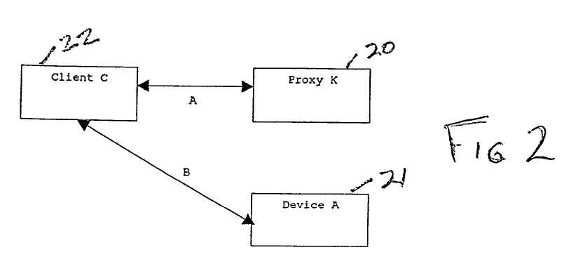

In FIG. 2, a proxy server 20 identifies the device 21 and the client 22 can access the device 21 directly. Step A is further subdivided into Aₛ, an HTTP Authorize/Redirect Start step and A_{S}, an HTTP Authorize/Redirect Finish step, which are shown on the FIG. 2 state transition diagrams. Step B is also subdivided into Bₛ an HTTP Request/Response Start, and B_{F} an HTTP Request/Response Finish step also shown on the state transitions diagram.

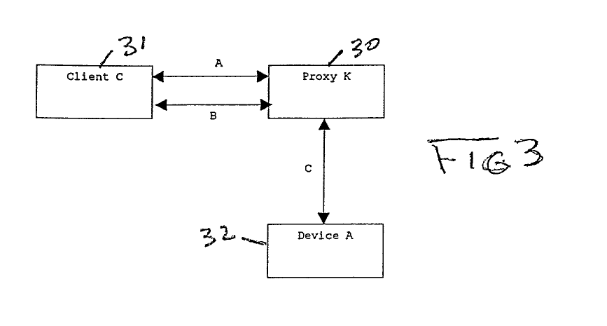

In FIG. 3, a proxy 30 forwards to an HTTP server, when the client 31 seeks a connection to device 32. As in FIG. 2, A_{S}, A_{F}, B_{S} and B_{F} indicate the same steps in the state transitions, while C_{S} indicates an HTTP Proxy Request/Response start, and C_{F} indicates a Proxy Request/Response Finish. In this case a proxy server 30 can identify and access to the device 32 but the device 32 is inaccessible to the client 31.

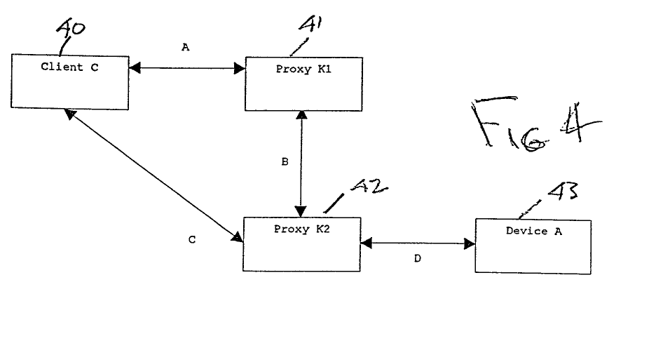

In FIG. 4, a client 40 accesses the proxy 41 which redirects to a second proxy 42 which is accessible to the client 42, and proxy 42 is accessible to the client 40. The state transitions are shown wherein A_{S}, A_{F}, B_{S}, B_{F}, C_{S} and C_{F} are as defined in relation to FIG. 3, and D_{S} indicates an HTTP proxy Request/Response start and D_{F} indicates an HTTP proxy Request/Response finish. As before the arrows in the State Transitions are indicative of the steps in the connection process, the oval arrow indicating a recursive step, such as B_{F} to B_{S} in FIG. 3, and C_{F} to C_{S} in FIG. 4. In this example shown in FIG. 4, the proxy 41 can identify the device 43, but access is through proxy 42, and proxy 42 is accessible to client 40.

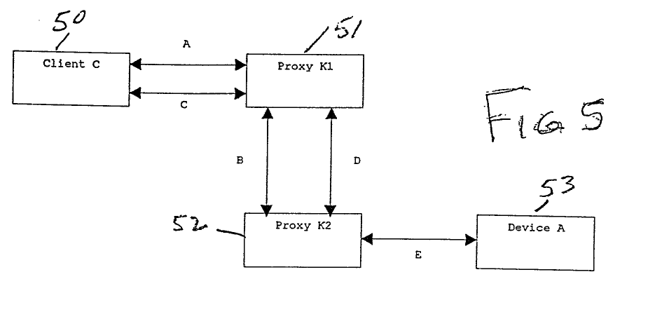

A further example is shown in FIG. 5 in which access is obtained through multiple proxies to an HTTP server. As before, a client 50 accesses a proxy 51 at A which can identify the device 53, but access is through a second proxy 52 at B and the second proxy 52 is inaccessible to the client 50. The state transitions A_{S}, A_{F}, B_{S}, B_{F}, C_{G}, C_{F}, D_{S}, D_{F} are as explained in relation to FIG. 4, and E_{S} is an HTTP proxy Request/Response start, and E_{F} is a proxy Request/Response finish. The recursive portion of the transitions is shown by the elliptical arrow, with the letters, A, B, C, D and E illustrating the states of the process from client 50 to proxy 51 to proxy 52 to device 53, and back through proxy 52 to proxy 51 and to client 50.

Other Applications of the Invention

The invention may also be used to proxy any connection-oriented TCP service. Typical services that can be supported by the invention include telnet and ftp. The invention can be used to launch any tcp service that can be launched using a url within a browser. The example below is for an application of this invention for the telnet protocol.

Launching of a telnet or ftp client is compliant with HTTP protocols 0.9, 1.0 and 1.1.

Proxy Configuration

Proxy configuration is identical to the method used for http servers.

Telnet URL

The invention redirects clients to the device or proxy by using a telnet url which will launch a telnet client that instantiates a connection using the ip address and TCP port specified in the URL. The URL is formatted as follows:

telnet://{ip}:{tcp port}

where ‘telnet’ is the protocol specifier. {ip} is either numeric IP address or fully qualified domain name, and {tcp port} is the tcp port that is used for the connection.

FTP URL

The invention redirects clients to the device or proxy by using a ftp url which will launch an ftp client that instantiates a connection using the ip address and TCP port specified in the URL. The URL is formatted as follows:

ftp://{ip}:{tcp port}

where ftp is the protocol specifier, {ip} is either a numeric IP address or fully qualified domain name, and {tcp port} is the tcp port that is used for the connection.

A person understanding the above-described invention may now conceive of alternative designs, using the principles described herein. All such designs which fall within the scope of the claims appended hereto are considered to be part of the present invention.

We claim:

1. A method for providing a proxy service in a computer network, comprising the steps of:
(a) receiving a request to access a device,
(b) determining the path to the device,
(c) ascertaining what firewall rules exist for that given path, and
(d) redirecting the client to the appropriate proxy, if any is needed, for that path.

2. The method of claim 1 wherein the ascertaining step comprises the step of using a network inventory to describe the devices that are to be considered by the proxy.

3. The method of claim 1 wherein the ascertaining step comprises the step of using device attributes apart from the native device IP address to select the device.

4. The method of claim 1 wherein the ascertaining step comprises the step of using an inventory of devices to distinguish devices that have IP numbering or network conflicts.

5. The method of claim 1 wherein the ascertaining step comprises the step of using physical topology information to determine the location of a device.

6. The method of claim 1 wherein the ascertaining step comprises the step of using physical topology information to determine and discriminate between non-routable networks with conflicting address information.

7. The method of claim 1 wherein the ascertaining step comprises the step of using physical topology information to determine and discriminate between non-routable networks with conflicting address information.

8. The method of claim 1 further including propagating path information to proxies.

9. The method of claim 1 further including authenticating for the client.

10. The method of claim 1 further including authenticating between proxies.

11. The method of claim 1 further including informing the remote proxy server of the client address.

12. The method of claim 1 further including informing the remote proxy server of the destination address.

13. The method of claim 1 further including determining the remaining path to be traversed for a given proxy.

14. The method of claim 1 further including a means o making proxy paths recursive.

15. The method of claim 1 further including creating a communications channel between proxies.

16. The method of claim 1 further including having an HTTP protocol request go from the client to the destination.

17. The method of claim 1 further including having an HTTP protocol response go from the destination to the client.

18. The method of claim 1 wherein when the service is performed, appear to the destination as coming from the source.

19. The method of claim 16 further including maintaining authentication between client and proxy after the HTTP request has completed.

20. The method of claim 17 further including maintaining authentication between proxies after the HTTP request has completed.

21. The method of claim 1 further including creating a communications channel between proxies.

22. The method of claim 1 further including having a TCP request go from the client to the destination.

23. The method of claim 1 further including having a TCP response go from the destination to the client.

24. The method of claim 1 wherein when the service is performed, appear to the destination as coming from the source.

25. The method of claim 22 further including maintaining authentication between client and proxy after the TCP request has completed.

26. The method of claim 23 further including maintaining authentication between proxies after the TCP request has completed.
